(19) United States
(12) Patent Application Publication
(10) Pub. No.: US 2018/0239870 A1
(43) Pub. Date: Aug. 23, 2018

(54) METHOD AND SYSTEM FOR IDENTIFYING AND ADDRESSING POTENTIAL HEALTHCARE-BASED FRAUD

(71) Applicant: Intuit Inc., Mountain View, CA (US)

(72) Inventors: Jonathan R. Goldman, Mountain View, CA (US); Monica Tremont Hsu, Burlingame, CA (US); Efraim Feinstein, Palo Alto, CA (US)

(73) Assignee: Intuit Inc., Mountain View, CA (US)

(21) Appl. No.: 15/220,981

(22) Filed: Jul. 27, 2016

(51) Int. Cl. G06F 19/00; G06Q 30/00

(52) U.S. Cl. CPC G06F 19/328; G06Q 30/0185

(57) ABSTRACT

Methods and systems of the present disclosure include identifying and addressing potential healthcare-based fraud, according to one embodiment. The methods and systems identify potential healthcare-based fraud associated with potentially suspicious healthcare providers, patients, and/or claim submissions, in one embodiment. According to one embodiment, the methods and systems acquire data associated with a healthcare provider, patient, and/or claim submission; apply the data to one or more predictive models to generate one or more risk scores to identify potential healthcare-based fraud, and perform one or more risk reduction actions based on the one or more risk scores, according to one embodiment.

### BACKGROUND

Healthcare is responsible for three trillion dollars worth of expenditures in this country and nearly twenty percent of the gross domestic product. Healthcare as an industry continues to grow and healthcare spending outpaces inflation. Unfortunately, healthcare-based fraud is responsible for a significant amount of that spending: healthcare-based fraud costs the citizens of the United States tens of billions of dollars per year.

When healthcare-based fraud is perpetrated, the cost of the fraud is passed along to healthcare consumers and taxpayers. Consumers are required to pay for the fraud through the cost of their insurance. Healthcare-based fraud hurts taxpayers by stealing resources from Medicare and Medicaid coffers that would otherwise benefit state and federal governments and individuals. Statistics show that one of every ten dollars spent on healthcare is used to pay a fraudulent healthcare claim.

Despite the consequences and prevalence of healthcare-based fraud, legislation requires that health care insurers pay a legitimate claim within 30 days. Because of this short timeline, the government agencies-including the Federal Bureau of Investigation, the U.S. Postal Service, and the Office of the Inspector General-tasked with investigating healthcare-based fraud rarely have enough time to conduct thorough investigations before payment is required.

What is needed is a method and system for identifying and addressing potential healthcare-based fraud, according to one embodiment.

### SUMMARY

Healthcare-based fraud is an example of cybercrime that includes healthcare providers engaging in fraudulent claim submission practices, including submitting fraudulent claims to an insurance entity for payment or providing a fraudulent bill to a patient. For example, healthcare providers engaging in healthcare-based fraud bill health insurers for phantom treatments, wherein the healthcare provider bills for treatments, tests, and/or equipment that were not provided and/or were unneeded. Other healthcare-based fraud includes activities such as double billing or triple billing.

Although service providers of claim submission systems such as insurance companies and government entities are not contributing to the healthcare-based fraud, potential healthcare-based fraud is a major concern to the service providers of the claim submission systems as they work to reduce, minimize, or eliminate fraudulent activity and to protect their customers' interests.

The present disclosure includes methods and systems for identifying and addressing potential healthcare-based fraud, according to one embodiment. To identify and address the potential healthcare-based fraud, a fraud detection system monitors healthcare provider data, health service data, claim submission data, and/or patient data to identify potentially suspicious healthcare provider data, potentially suspicious health service data, and/or potentially suspicious claim submission data.

In one embodiment, the fraud detection system receives claim submission data that includes healthcare provider data, generates one or more risk scores based on the healthcare provider data, and performs one or more risk reduction actions based on the likelihood of potential healthcare-based fraud that is represented by the one or more risk scores, according to one embodiment.

The one or more risk scores individually and/or cumulatively represent a likelihood of potential healthcare-based fraud, according to one embodiment. In one embodiment, the claim submission data associated with one or more risk scores that individually and/or cumulatively represent a likelihood of potential healthcare-based fraud is defined as potentially suspicious claim submission data. In one embodiment, the healthcare provider data associated with one or more risk scores that individually and/or cumulatively represent a likelihood of potential healthcare-based fraud is defined as potentially suspicious healthcare provider data.

Each potentially suspicious claim submission and/or potentially suspicious healthcare provider is associated with a subset of input data stored and/or maintained by the claim submission systems and/or the fraud detection system, according to one embodiment. The fraud detection system processes the input data to determine various types of risk scores, according to one embodiment. The one or more risk scores include risk scores for risk categories such as characteristics of a healthcare provider, characteristics of a health service, characteristics of a claim submission, an IP address of a user computing system used to access the claim submission system, user system characteristics of a user computing system used to access the claim submission system, system access characteristics, an account of a user for the claim submission system, and user characteristics of a user of the claim submission system, according to one embodiment.

The fraud detection system generates the one or more risk scores using one or more predictive models that are trained to identify potential healthcare-based fraud, according to one embodiment. The one or more predictive models are trained using at least some healthcare provider data that has been associated with healthcare-based fraud, which enables the one or more predictive models to generate scores that represent the likelihood of healthcare-based fraud based on analysis of prior cases, according to one embodiment.

The risk reduction actions include one or more techniques to address potential healthcare-based fraud, according to one embodiment. The risk reduction actions include, but are not limited to, one or more of the following: notifying the healthcare provider of potential healthcare-based fraud associated with the potentially suspicious healthcare provider; notifying a manager of the healthcare provider of potential healthcare-based fraud associated with the potentially suspicious healthcare provider; notifying a controller of the healthcare provider of potential healthcare-based fraud associated with the potentially suspicious healthcare provider; notifying an auditor of potential healthcare-based fraud associated with the potentially suspicious healthcare provider; notifying a government entity of potential healthcare-based fraud associated with the potentially suspicious healthcare provider; notifying a healthcare provider network of potential healthcare-based fraud associated with the potentially suspicious healthcare provider; notifying a government entity of potential healthcare-based fraud associated with the potentially suspicious healthcare provider; notifying law enforcement agencies of potential healthcare-based fraud associated with the potentially suspicious healthcare provider; suspending insurance claim submissions associated with the potentially suspicious healthcare provider; and assigning customer support representatives to contact people who were or are patients of the potentially suspicious healthcare provider. Additional embodiments of risk reduction actions are disclosed in more detail below.

The fraud detection system generates the one or more risk scores and performs the one or more risk reduction actions based on input data, according to one embodiment. In one embodiment, the fraud detection system uses one or more of claim submission data; healthcare provider data; health service data; user data; system access data; and/or user system data, according to one embodiment.

In one embodiment, the fraud detection system receives system access data for a user system. The system access data includes information associated with a user interacting with the claim submission system, according to one embodiment. The system access data represents system access activities of one or more users with the claim submission system, according to one embodiment. The system access data includes, but is not limited to, identification of the computing system used to access the claim submission system, an Internet browser and/or an operating system of the computing system used to access the claim submission system, clickstream data generated while accessing the claim submission system, Internet Protocol (“IP”) address characteristics of the computing system used to access the claim submission system, and the like. The system access data includes claim submissions. For example, claim submissions can include the particular types of claims that are submitted by a particular healthcare provider. The claim submissions of a particular healthcare provider are compared to those of other healthcare providers having similar practice sizes, similar patient demographics, similar geographical location, similar specialties, similar educational backgrounds, similar revenue, and/or similar years of experience, according to one embodiment. Additional examples of system access data and/or system access activities are provided below.

The fraud detection system works with the claim submission system to identify and address the potentially fraudulent activity, according to one embodiment. In one embodiment, the functionality/features of the fraud detection system are integrated into the claim submission system. In one embodiment, the fraud detection system shares one or more resources with the claim submission system in a service provider computing environment. In one embodiment, the fraud detection system requests the information that is used for identification of potentially fraudulent activity from the claim submission system. These and other embodiments of the claim submission system and the fraud detection system are discussed in further detail below.

By identifying and addressing potential healthcare-based fraud, implementation of embodiments of the present disclosure allows for significant improvement to the fields of data security, healthcare systems, insurance systems, claim submission systems security, data collection, and data processing, according to one embodiment.

As illustrative examples, by identifying and addressing potential healthcare-based fraud, fraudsters can be deterred from criminal activity, insurance companies may retain/build trusting relationships with customers, governments may be spared financial losses, criminally funded activities may be decreased due to less or lack of funding, and healthcare costs may be decreased.

As another example, by identifying and implementing risk-reducing actions, fraudulent claim submissions to insurance companies, the government, and other claim submission system service providers may be reduced. As a result, embodiments of the present disclosure allow for reduced communication channel bandwidth utilization and faster communications connections. Consequently, computing and communication systems implementing and/or providing the embodiments of the present disclosure are transformed into faster and more operationally efficient devices and systems.

### BRIEF DESCRIPTION OF THE DRAWINGS

FIG. 1 is a block diagram of software architecture for identifying and addressing potential healthcare-based fraud, in accordance with one embodiment.

FIG. 2 is a flow diagram of a process for identifying and addressing potential healthcare-based fraud, according to one embodiment.

FIG. 3 is a flow diagram of a process for identifying and addressing potential healthcare-based fraud, according to one embodiment.

FIG. 4 is a flow diagram of a process for identifying and addressing potential healthcare-based fraud, according to one embodiment.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying figures, which depict one or more exemplary embodiments. Embodiments may be implemented in many different forms and should not be construed as limited to the embodiments set forth herein, shown in the figures, and/or described below. Rather, these exemplary embodiments are provided to allow a complete disclosure that conveys the principles of the invention, as set forth in the claims, to those of skill in the art.

The INTRODUCTORY SYSTEM, HARDWARE ARCHITECTURE, and PROCESS sections herein describe systems and processes suitable for identifying and addressing potential healthcare-based fraud activity, according to various embodiments.

### Introductory System

Herein, a “system” (e.g., a software system) can be, but is not limited to, any data management system implemented on a computing system, accessed through one or more servers, accessed through a network, accessed through a cloud, and/or provided through any system or by any means, as discussed herein, and/or as known in the art at the time of filing, and/or as developed after the time of filing, that gathers/obtains data, from one or more sources and/or has the capability to analyze at least part of the data, in one embodiment.

As used herein, the term “system” includes, but is not limited to the following: computing system implemented, and/or online, and/or web-based, personal and/or business healthcare management systems, services, packages, programs, modules, or applications; computing system implemented, and/or online, and/or web-based, personal and/or business management systems, services, packages, programs, modules, or applications; computing system implemented, and/or online, and/or web-based, personal and/or business accounting and/or invoicing systems, services, packages, programs, modules, or applications; and various other personal and/or business electronic data management systems, services, packages, programs, modules, or applications, whether known at the time of filling or as developed later.

As used herein, the terms “computing system,” “computing device,” and “computing entity,” include, but are not limited to, the following: a server computing system; a workstation; a desktop computing system; a mobile computing system, including, but not limited to, smart phones, portable devices, and/or devices worn or carried by a user; a database system or storage cluster; a virtual asset; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms “computing system” and “computing entity,” can denote, but are not limited to the following: systems made up of multiple virtual assets, server computing systems, workstations, desktop computing systems, mobile computing systems, database systems or storage clusters, switching systems, routers, hardware systems, communications systems, proxy systems, gateway systems, firewall systems, load balancing systems, or any devices that can be used to perform the processes and/or operations as described herein.

Herein, the term “production environment” includes the various components, or assets, used to deploy, implement, access, and use, a given system as that system is intended to be used. In various embodiments, production environments include multiple computing systems and/or assets that are combined, communicatively coupled, virtually and/or physically connected, and/or associated with one another, to provide the production environment implementing the application.

As specific illustrative examples, the assets making up a given production environment can include, but are not limited to, the following: one or more computing environments used to implement at least part of the system in the production environment such as a data center, a cloud computing environment, a dedicated hosting environment, and/or one or more other computing environments in which one or more assets used by the application in the production environment are implemented; one or more computing systems or computing entities used to implement at least part of the system in the production environment; one or more virtual assets used to implement at least part of the system in the production environment; one or more supervisory or control systems, such as hypervisors, or other monitoring and management systems used to monitor and control assets and/or components of the production environment; one or more communications channels for sending and receiving data used to implement at least part of the system in the production environment; one or more access control systems for limiting access to various components of the production environment, such as firewalls and gateways; one or more traffic and/or routing systems used to direct, control, and/or buffer data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement at least part of the system in the production environment; one or more databases used to store data in the production environment; one or more internal or external services used to implement at least part of the system in the production environment; one or more backend systems, such as backend servers or other hardware used to process data and implement at least part of the system in the production environment; one or more modules/functions used to implement at least part of the system in the production environment; and/or any other assets/components making up an actual production environment in which at least part of the system is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, systems, and networking/communications systems. Typically, computing environments are either known, “trusted” environments or unknown, “untrusted” environments. Typically, trusted computing environments are those where the assets, infrastructure, communication and networking systems, and fraud detection systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate at least part of the system.

In various embodiments, one or more cloud computing environments are used to create, and/or deploy, and/or operate at least part of the system that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given system or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, the following: virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing can be implemented as one or more virtual assets within one or more cloud or traditional computing environments.

In one embodiment, two or more assets, such as computing systems and/or virtual assets, and/or two or more computing environments are connected by one or more communications channels including but not limited to, Secure Sockets Layer (SSL) communications channels and various other secure communications channels, and/or distributed computing system networks, such as, but not limited to the following: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, the following: a peer-to-peer network; a hybrid peer-to-peer network; a Local Area Network (LAN); a Wide Area Network (WAN); a public network, such as the Internet; a private network; a cellular network; any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the terms “user experience” and “user experience display” include user experience features and elements provided or displayed to the user such as, but not limited to the following: data entry fields, question quality indicators, images, backgrounds, avatars, highlighting mechanisms, icons, buttons, controls, menus and any other features that individually, or in combination, create a user experience, as discussed herein, and/or as known in the art at the time of filing, and/or as developed after the time of filing.

Herein, the term “entity,” “party,” “user,” “user consumer,” and “customer” are used interchangeably to denote any party and/or entity that interfaces with, and/or to whom information is provided by, the disclosed methods and systems described herein, and/or a legal guardian of person and/or entity that interfaces with, and/or to whom information is provided by, the disclosed methods and systems described herein, and/or an authorized agent of any party and/or person and/or entity that interfaces with, and/or to whom information is provided by, the disclosed methods and systems described herein. For instance, in various embodiments, a user can be, but is not limited to, a person, a healthcare provider, an insurance company, a government entity, a commercial entity, an application, a service, and/or a computing system.

As used herein, the term “healthcare provider” includes any provider of medical and/or health services and/or supplies; and/or any other person and/or organization who furnishes, bills, or is paid for health care services and/or supplies in the normal course of business.

As used herein, the term “predictive model” is used interchangeably with “analytics model” and denotes one or more individual or combined algorithms or sets of equations that describe, determine, and/or predict characteristics of or the performance of a datum, a data set, multiple data sets, a computing system, and/or multiple computing systems. Analytics models or analytical models represent collections of measured and/or calculated behaviors of attributes, elements, or characteristics of data and/or computing systems.

As used herein, the term “identification number” includes, but is not limited to, a National Provider Identifier (NPI); a Provider Identification Number (PIN); a Unique Physician Identification Number (UPIN); a Blue Cross Blue Shield Number; an Online Survey Certification and Reporting (OSCAR) system number; a National Supplier Clearinghouse (NSC) number; a social security number; and an Employer Identification Number.

As used herein the term “system access data” denotes data that represents the activities of a user during the user's interactions with a system, and represents system access activities and the features and/or characteristics of those activities, according to various embodiments.

As used herein, the term “risk categories” denotes characteristics, features, and/or attributes of users or healthcare provider systems, and represents subcategories of risk that may be used to quantify potentially fraudulent activity, according to various embodiments.

### Hardware Architecture

The present disclosure includes methods and systems for identifying and addressing potential healthcare-based fraud in a healthcare system, according to one embodiment. In one embodiment, a fraud detection system identifies and addresses potential healthcare-based fraud in claim submission system. To identify and address the potential healthcare-based fraud, the fraud detection system receives input data from a claim submission system, generates one or more risk scores based on the input data, and performs one or more risk reduction actions based on the likelihood of potential healthcare-based fraud that is represented by the one or more risk scores, according to one embodiment.

In other words, in one embodiment, when a user associated with a healthcare provider submits an insurance claim to a claim submission system, the claim submission system provides the claim submission data to the fraud detection system. The fraud detection system analyzes the claim submission data to identify potential healthcare based-fraud associated with the claim submission data, in one embodiment. In one embodiment, the claim submission system and the fraud detection system are one system.

In one embodiment, the claim submission system receives and stores input data from a user system, such as a healthcare provider system. In one embodiment, the claim submission system receives and stores claim submission data representing a claim submission from a user system. In one embodiment, the claim submission system receives and stores claim submission data including health service data, representing health services and goods provided by a healthcare provider. In one embodiment, the claim submission system receives and stores healthcare provider data representing characteristics of a healthcare provider. In one embodiment, the claim submission system receives and stores patient data representing characteristics of a patient of a healthcare provider.

As disclosed below, the fraud detection system uses the input data such as the claim submission data, the health service data, the healthcare provider data, and/or the patient data, as well as other input data, to generate risk scores and to perform risk reduction actions, according to various embodiments.

To identify potential healthcare-based fraud, the fraud detection system analyzes the input data to identify patterns indicative of fraudulent activity. For example, a claim submission containing a jaw x-ray for a patient diagnosed as suffering with depression may indicate potential healthcare-based fraud because a jaw x-ray is not indicated for the treatment or diagnosis of depression. Likewise, a claim submission from a healthcare provider specializing in dermatological services for mental health therapy for a patient suffering from depression is another indication of potential healthcare-based fraud as a dermatology healthcare provider does not normally provide mental health therapy. In these scenarios, it is possible that the claim submissions are attempts at potential healthcare-based fraud.

As discussed herein, embodiments of the present disclosure identify and address potential healthcare-based fraud by analyzing patterns and/or factors indicative of fraudulent activity. In one embodiment, the software system analyzes several factors concurrently, with predictive models, to determine the likelihood of potential healthcare-based fraud.

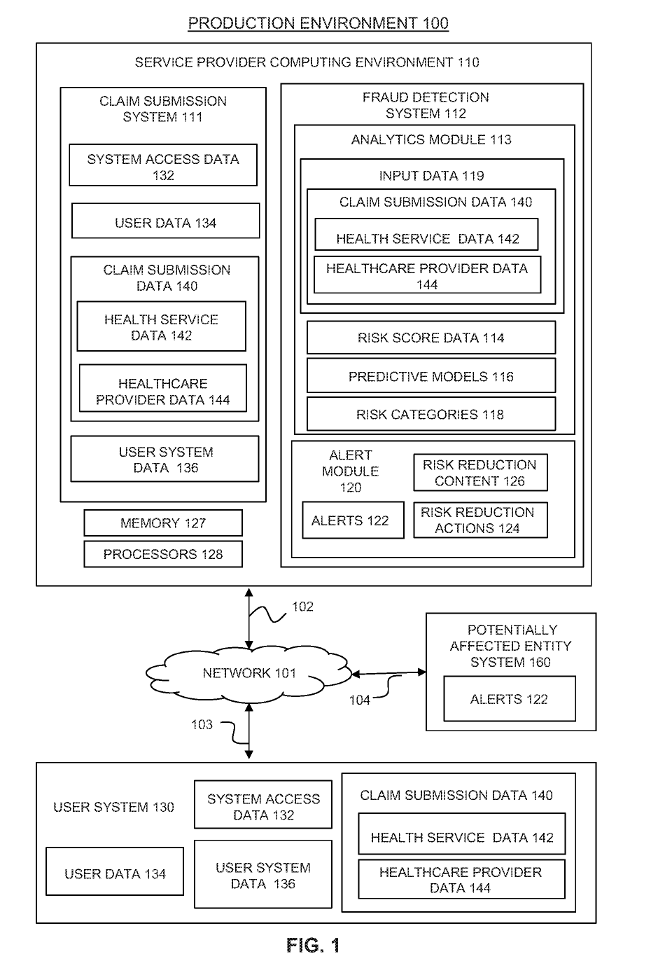

FIG. 1 is an example block diagram of a production environment 100 for identifying and addressing potential healthcare-based fraud, in accordance with one embodiment. The production environment 100 illustrates example communications between a service provider computing environment 110, a user system 130, and a potentially affected entity system 160, to describe embodiments of how a fraud detection system may identify and address potential healthcare-based fraud, in one embodiment.

The service provider computing environment 110 is communicatively coupled to the user system 130 and the potentially affected entity system 160 through a network 101 and through communications channels 102, 103, and 104, according to one embodiment.

In one embodiment, the user system 130 is used to communicate with and/or interact with the claim submission system 111, according to one embodiment. The user system 130 is representative of one of hundreds, thousands, or millions of user systems used by users to access the claim submission system 111, according to one embodiment. In one embodiment, only one authorized user uses the user system 130 to access the claim submission system 111. In one embodiment, the user system 130 is a company computer or a public computer that is used by multiple authorized users to access the claim submission system 111.

In one embodiment, the user system 130 includes system access data 132; user data 134; user system data 136; and claim submission data 140, including health service data 142 and healthcare provider data 144.

The system access data 132 is data that represents system access activities and the features and/or characteristics of those activities, according to one embodiment. The system access activities may occur before, during, and/or after the user system 130 establishes a communications channel/connection with the claim submission system 111, according to one embodiment. The system access data 132 includes, but is not limited to, data representing the following: user entered data, event level data, the web browser of a user's computing system, the operating system of a user's computing system, the media access control (“MAC”) address of the user's computing system, hardware identifiers of the user's computing system, user credentials used for logging in, a user account identifier, interaction behavior, the IP address of the user's computing system, a session identifier, interaction behavior during prior sessions, interaction behavior using different computing systems to access the claim submission system 111, interaction behavior from IP addresses other than a current IP address, IP address characteristics, whether changes are made to user characteristics data, and any other feature/characteristic of system access activity that is currently known at the time of filing or that may be known at a later time for interacting with a claim submission system, according to one embodiment.

In one embodiment, the user data 134 includes user characteristics data. The user characteristics data includes one or more identification numbers, including but not limited to, a National Provider Identifier (NPI); a Provider Identification Number (PIN); a Unique Physician Identification Number (UPIN); a Blue Cross Blue Shield Number; an Online Survey Certification and Reporting (OSCAR) system number; a National Supplier Clearinghouse (NSC) number; a social security number; and an Employer Identification Number, or any other information that can be used to distinguish one user and/or individual (e.g., person or organization) from another, according to one embodiment. In one embodiment, event level data includes data that represents events such as filing a tax return, logging into a user account, entering information into the user account, navigating from one user experience page to another, and the like.

The user data 134 includes, but is not limited to, data representing the type of the healthcare provider; location of the healthcare provider; size of the healthcare provider; historical data associated with the healthcare provider; statistical data associated with the healthcare provider; population served by the healthcare provider; healthcare services provided by the healthcare provider; healthcare items provided by the healthcare provider; drugs prescribed the healthcare provider; number of prescriptions provided by the healthcare provider; number of insurance claims associated with the healthcare provider; number of employees of the healthcare provider; whether the healthcare provider is part of a larger healthcare provider network; change in income of the healthcare provider; and change in number of insurance claims associated with the healthcare provider.

The user data 134 includes, but is not limited to, data representing the following: browsing/navigation behavior within the claim submission system 111, type of web browser, type of operating system, manufacturer of computing system, whether the user's computing system is a mobile device or not, according to various embodiments.

The user system data 136 include one or more of an operating system, a hardware configuration, a web browser, information stored in one or more cookies, the geographical history of use of the user system 130, an IP address associated with the user system 130, and other forensically determined characteristics/attributes of the user system 130, according to one embodiment. The user system data 136 are represented by a user system characteristics identifier that corresponds with a particular set of user system characteristics during one or more user sessions with the claim submission system 111, according to one embodiment. Because the user system 130 may use different browsers or different operating systems at different times to access the claim submission system 111, the user system data 136 for the user system 130 may be assigned several user system characteristics identifiers, according to one embodiment. The user system characteristics identifiers are called the visitor identifiers (“VIDs”), according to one embodiment.

The IP address associated with the user system 130 is part of the user system data 136 and can be static, can be dynamic, and/or can change based on the location for which the user system 130 accesses the claim submission system 111, according to one embodiment. The claim submission system 111 and/or the fraud detection system 112 may use an IP address identifier to represent the IP address and/or additional characteristics of the IP address associated with the user system 130, according to one embodiment.

The user clickstream data associated with user system 130 is part of the user system data 136 and represents the browsing/navigation behavior of one or more users of the user system 130 while interacting with the claim submission system 111, according to one embodiment. The clickstream data associated with user system 130 is captured and/or stored in the system access data 132 and/or the user data 134, according to one embodiment.

The user system characteristics are part of the user system data 136 and are associated with a user system characteristics identifier, which can be generated based on a combination of the hardware and software used by the user system 130 to access the claim submission system 111 during one or more sessions, according to one embodiment. The user system characteristics are associated with a user system characteristics identifier, which can be generated based on a combination of the hardware and software used by the user system 130 to access the claim submission system 111, according to one embodiment. As discussed above, the system access data 132 and/or the user data 134 include the user system characteristics, the IP address associated with the user system 130, and the clickstream data associated with the user system 130, according to one embodiment.

In one embodiment, the claim submission data 140 includes, but is not limited to, any filing related to the health service data 142, such as a health insurance claim. In one embodiment, the user system 130 is the source of the claim submission data 140 because the user system 130 is used to file insurance claim submissions for a first user. In one embodiment, the first user files insurance claim submissions on behalf of a health service provider. Accordingly, the user system 130 represents a portal for the health service provider to file insurance claim submissions, according to one embodiment.

In one embodiment, the claim submission data 140 includes, but is not limited to, data representing type of the claim submission; one or more procedures associated with the claim submission; one or more services associated with the claim submission; one or more supplies associated with the claim submission; equipment associated with the claim submission; one or more diseases associated with the claim submission; one or more conditions associated with the claim submission healthcare provider associated with the claim submission; a patient associated with the claim submission; one or more codes associated with the claim submission; historical data associated with the claim submission; and/or statistical data associated with the claim submission.

In one embodiment, health service data 142 represents any service and/or supply provided by a healthcare provider, associated with healthcare, and/or received by a patient. In one embodiment, the health service data 142 includes code data representing health items and services. In one embodiment, the health service data includes codes as defined in the Current Procedural Terminology (CPT)/Healthcare Common Procedure Coding System (HCPCS) Codes (Code List), which identifies all the items and services included within certain DHS categories. In one embodiment, the health service risk category includes a health service code risk category.

In one embodiment, the healthcare provider data 144 includes any data representing general or identifying characteristics of a healthcare provider. In one embodiment, the healthcare provider data 144 includes data representing one or more identification numbers. In one embodiment, the one or more identification numbers include, but are not limited to, a National Provider Identifier (NPI); a Provider Identification Number (PIN); a Unique Physician Identification Number (UPIN); a Blue Cross Blue Shield Number; an Online Survey Certification and Reporting (OSCAR) system number; a National Supplier Clearinghouse (NSC) number; a social security number; and an Employer Identification Number, or any other information that can be used to distinguish one healthcare provider from another, according to one embodiment.

The service provider computing environment 110 includes the claim submission system 111 and the fraud detection system 112 that is used to identify and address potential healthcare-based fraud in the claim submission system 111, according to one embodiment. The service provider computing environment 110 includes one or more centralized, distributed, and/or cloud-based computing systems that are configured to host the claim submission system 111 and the fraud detection system 112 for a service provider, according to one embodiment. The claim submission system 111 establishes one or more user accounts with one or more users of the user system 130 by communicating with the user system 130 through the network 101, according to one embodiment.

The fraud detection system 112 uses information from the claim submission system 111 to identify the activities of the user system 130 as potentially fraudulent, to determine the likelihood of potentially healthcare-based fraudulent activity from the user system 130, and to take one or more risk reduction actions to prevent fraudulent activity in the claim submission system 111, according to one embodiment.

The claim submission system 111 provides one or more claim submission services to users of the claim submission system 111, according to one embodiment. The claim submission system 111 enables users, such as the users of the user system 130, to interact with the claim submission system 111 based on one or more user accounts that are associated with the users of the user system 130, according to one embodiment.

The claim submission system 111 acquires, receives, maintains and/or stores the system access data 132; the claim submission data 140, including the health service data 142 and the healthcare provider data 144; the user data 134; and the user system data 136, according to one embodiment.

The claim submission system 111 creates, stores, and manages the system access data 132, at least partially based on interactions of healthcare provider systems, including user system 130, with the claim submission system 111, according to one embodiment. The system access data 132 is stored as a table, a database, or some other data structure, according to one embodiment. The system access data 132 can include tens, hundreds, or thousands of features or characteristics associated with an interaction between a healthcare provider system and the claim submission system 111, according to one embodiment.

In one embodiment, the fraud detection system 112 uses the system access data 132 that is based on one or more sessions between the claim submission system 111 and the user system 130 to identify and address potentially fraudulent activities, according to one embodiment. For example, the fraud detection system 112 analyzes the system access data 132 at least partially based on the number and characteristics of sessions entered into by a particular healthcare provider system, according to one embodiment. A session-by-session analysis of system access data 132 can be used to show which healthcare provider systems are accessing multiple user accounts, in addition to the nature/behavior of the accesses, according to one embodiment.

The claim submission system 111 creates, stores, and/or manages the claim submission data 140, in one embodiment. In one embodiment, the claim submission data 140 includes health service data 142. The health service data 142 is stored in a table, database, or other data structure, according to one embodiment. The claim submission system 111 receives and/or obtains the health service data 142 directly from the user system 130, according to one embodiment. The claim submission system 111 receives and/or obtains the health service data 142 from one or more third party systems, such as healthcare providers, insurance companies, public records, government agencies, etc., according to one embodiment.

The claim submission system 111 creates, stores, and/or manages the user data 134 that is associated with users of the claim submission system 111, according to one embodiment. In one embodiment, the user data 134 is stored in a table, database, or some other data structure, according to one embodiment.

To determine the likelihood that claim submission data 140, health service data 142, or healthcare provider data 144 associated with the user system 130 (or any other healthcare provider system) is associated with potentially healthcare-based fraud activities, the fraud detection system 112 uses an analytics module 113 and an alert module 120, according to one embodiment. Although embodiments of the functionality of fraud detection system 112 will be described in terms of the analytics module 113 and the alert module 120, the fraud detection system 112, the claim submission system 111, and/or service provider computing environment 110 may use one or more alternative terms and/or techniques for organizing the operations, features, and/or functionality of the fraud detection system 112 that is described herein. In one embodiment, the fraud detection system 112 (or the functionality of the fraud detection system 112) is partially or wholly integrated/incorporated into the claim submission system 111.

The fraud detection system 112 generates risk score data 114 for input data 119, to determine a likelihood of potential healthcare-based fraud in the claim submission system 111, according to one embodiment.

The fraud detection system 112 generates risk score data 114 for claim submission data 140, to determine a likelihood of potential healthcare-based fraud in the claim submission system 111, according to one embodiment.

The fraud detection system 112 generates risk score data 114 for health service data 142, to determine a likelihood of potential healthcare-based fraud in the claim submission system 111, according to one embodiment.

The fraud detection system 112 generates risk score data 114 for healthcare provider data 144, to determine a likelihood of potential healthcare-based fraud in the claim submission system 111, according to one embodiment.

The analytics module 113 and/or the fraud detection system 112 acquire input data 119, including claim submission data 140, health service data 142, and/or healthcare provider data 144 from the claim submission system 111 and/or from a centralized location where the claim submission data 140 is stored for use by the claim submission system 111, according to one embodiment.

The analytics module 113 and/or the fraud detection system 112 applies the claim submission data 140 to one or more predictive models 116, to generate the risk score data 114 that represents one or more risk scores, according to one embodiment.

In one embodiment, the analytics module 113 and/or the fraud detection system 112 applies various input data 119 to one or more predictive models 116, to generate the risk score data 114 that represents one or more risk scores.

The analytics module 113 and/or the fraud detection system 112 defines the likelihood of potential healthcare-based fraud at least partially based on the risk scores (represented by the risk score data 114) that are output from the one or more predictive models 116, according to one embodiment.

The analytics module 113 and/or the fraud detection system 112 uses one or more of the predictive models 116 to generate risk score data 114 for one or more risk categories 118, according to one embodiment.

In one embodiment, the risk categories 118 represent risk categories associated with characteristics, features, and/or attributes of one or more of the healthcare provider; claim submission, including an insurance claim submission; system access; and/or user system.

In one embodiment, the risk categories 118 are defined as one or more of the following: a healthcare provider risk category; a healthcare provider type risk category; a healthcare provider characteristics risk category; a healthcare provider statistical risk category; a healthcare provider insurance claim submission risk category; a healthcare provider insurance claim submission characteristics risk category; a claim submission type risk category; a claim submission characteristics risk category; a claim submission statistical risk category; a health service risk category; a system access risk category; a user risk category; and a user system risk category.

In one embodiment, input data 119 for the risk categories 118 includes, but is not limited to, claim submission data 140, health service data 142, healthcare provider data 144, system access data 132, user data 134, and user system data 136.

In one embodiment, each of the predictive models 116 receives the input data and generates a risk score (represented by the risk score data 114) for each of the risk categories 118.

To illustrate with an example, in one embodiment, the analytics module 113 receives claim submission data 140. In one embodiment, the analytics module 113 applies the claim submission data 140 to one of the predictive models 116. In one embodiment, the predictive model generates a risk score of 0.72 (represented by the risk score data 114) for the claim submission data 140 of the user system 130.

In one embodiment, the analytics module 113 and/or the fraud detection system 112 determines whether a risk score of 0.72 is a strong enough indication of a security threat to warrant performing one or more risk reduction actions.

As described, in one embodiment, the fraud detection system 112 uses one or more of the claim submission data 140, the health service data 142, the healthcare provider data 144, the system access data 132, the user data 134, and the user system data 136 to determine the likelihood that claim submission data 140 is associated with a potentially suspicious healthcare provider or is potentially suspicious claim submission data, according to one embodiment.

Each of the predictive models 116 can be trained to generate the risk score data 114 based on multiple risk categories 118, according to one embodiment. Each of the one or more predictive models 116 can be trained to generate a risk score or risk score data 114 for one particular risk category (e.g., healthcare provider risk category, health service risk category, healthcare provider characteristics risk category, claim submission risk category, etc.), according to one embodiment.

The risk score data 114 represents a risk score that is a number (e.g., a floating-point number) ranging from 0-1 (or some other range of numbers), according to one embodiment. In one embodiment, the closer the risk score is to 0, the lower the likelihood is that potential healthcare-based fraud has occurred and/or is occurring for a particular risk category. In one embodiment, the closer the risk score is to 1, the higher the likelihood is that potential healthcare-based fraud has occurred and/or is occurring for a particular risk category.

For example, if the analytics module returns a risk score of 0.82 for the claim submission risk category, it would be more likely than not that the claim submission is associated with activity that one or more of the predictive models 116 has been trained to identify as potential healthcare-based fraud, according to one embodiment.

One or more of the predictive models 116 is trained using information from the claim submission system 111 that has been identified or reported as being linked to some type of fraudulent activity, according to one embodiment. For example, in one embodiment, personnel associated with the claim submission system 111 learn that a healthcare provider has been engaged in healthcare-based fraud. When the personnel investigate the claim submissions associated with the healthcare provider, they may determine that the claim submissions were associated with potential healthcare-based fraud, in one embodiment. The personnel then provide, to the fraud detection system, input data associated with the healthcare provider. By providing the input data to the fraud detection system 112, the fraud detection system 112 is able to use the information to train one or more of the predictive models 116 to detect similar occurrences of fraudulent activity, according to one embodiment.

In one embodiment, one or more of the predictive models 116 are trained using existing information from the claim submission system 111, which includes non-fraudulent data and fraudulent data. By training the models based on all existing data, the models are configured to determine which input data 119 is associated with activities that are outside of standard, “normal”, statistically average behavior for a healthcare professional and/or for a claim submitted by a healthcare professional, according to one embodiment.

One or more predictive model building techniques are applied to the system access data 132, user data 134, user system data 136, claim submission data 140, health service data 142, and/or healthcare provider data 144 to generate one or more of the predictive models 116 for one or more of the risk categories 118, according to one embodiment. One or more predictive model building techniques is applied to fraud data that is reported to the fraud detection system 112 by customer support personnel or by fraud investigation teams, to generate one or more of the predictive models 116, according to one embodiment.

The one or more predictive models 116 are trained using one or more of a variety of machine learning techniques including, but not limited to, regression, logistic regression, decision trees, artificial neural networks, support vector machines, linear regression, nearest neighbor methods, distance based methods, naive Bayes, linear discriminant analysis, k-nearest neighbor algorithm, or another mathematical, statistical, logical, or relational algorithm to determine correlations or other relationships between the likelihood of potential healthcare-based fraud activity and the fraud data that is reported to the fraud detection system 112 by customer support personnel or by fraud investigation teams, according to one embodiment.

The analytics module 113 and/or the fraud detection system 112 can use the risk scores represented by the risk score data 114 in a variety of ways, according to one embodiment. In one embodiment, a determination to take corrective action or to take risk reduction actions is based on a risk score for one of the risk categories 118. In one embodiment, a determination to take corrective action or to take risk reduction action is based on a combination of risk scores for two or more of the risk categories 118.

In one embodiment, the predictive models 116 are applied to input data 119 that represents a low likelihood for potential healthcare-based fraud as well as to input data 119 that represents a high likelihood for potential healthcare-based fraud, to define risk score thresholds to apply to the risk score data 114, according to one embodiment. In one embodiment, the risk score data 114 is compared to one or more predefined risk score thresholds to determine if one or more of the risk categories 118 has a high enough likelihood of potential healthcare-based fraud characteristics to warrant performing risk reduction actions. Examples of risk score thresholds include 0.8 for health service, 0.95 for healthcare provider, and 0.65 for patient, according to one example of an embodiment. These values are merely illustrative and are determined based on applying the predictive models 116 to existing input data, according to one embodiment.

By defining and applying risk score thresholds to the risk score data 114, the fraud detection system 112 can control the number of false-positive and false-negative determinations of potentially fraudulent activity between healthcare provider systems and/or claim submissions associated with healthcare provider systems and the claim submission system 111, according to one embodiment. When a healthcare provider and/or claim submission is identified as having a high likelihood of association with potential healthcare-based fraud, the fraud detection system 112 executes one or more risk reduction actions 124, according to one embodiment.

However, if the fraud detection system 112 flags a healthcare provider as having a high likelihood of association with potential healthcare-based fraud when the healthcare provider is not associated with potential healthcare-based fraud, then the flagged activity is a false-positive and the user associated with the healthcare provider is inconvenienced with proving he or she is not associated with potential healthcare-based fraud and/or with being blocked from accessing the claim submission system 111, according to one embodiment. Thus, tuning the claim submission system 111 and/or the risk score thresholds to control the number of false-positive determinations will improve users' experience with the claim submission system 111, according to one embodiment.

A less-desirable scenario than flagging a business entity as false-positive might be flagging a healthcare provider as false-negative for potential healthcare-based fraud in the claim submission system 111, according to one embodiment. If the fraud detection system 112 flags the healthcare provider as not being associated with potential healthcare-based fraud when in fact the healthcare provider has a high likelihood of being associated with potential healthcare-based fraud, then the non-flagged healthcare provider is a false-negative, and the potentially suspicious healthcare provider has a continued opportunity to commit fraud, according to one embodiment. Thus, tuning the fraud detection system and/or the risk score thresholds to control the number of false-negative determinations will improve the ability of the claim submission system 111 to identify and address potential healthcare-based fraud, according to one embodiment.

The fraud detection system 112 uses the alert module 120 to execute one or more risk reduction actions 124, upon determining that all or part of the risk score data 114 indicates a likelihood of potential healthcare-based fraud, according to one embodiment. The alert module 120 is configured to coordinate, initiate, or perform one or more risk reduction actions 124 in response to detecting and/or generating one or more alerts 122, according to one embodiment.

The alert module 120 and/or the fraud detection system 112 is configured to compare the risk score data 114 to one or more risk score thresholds to quantify the level of risk associated with one or more of input data 119, claim submission data 140, health service data 142, and/or healthcare provider data 144, according to one embodiment. The alerts 122 include one or more flags or other indicators that are triggered, in response to at least part of the risk score data 114 exceeding one or more risk score thresholds, according to one embodiment. The alerts 122 include an alert for each one of the risk categories 118 that exceeds a predetermined and/or dynamic risk score threshold, according to one embodiment. The alerts 122 include a single alert that is based on a sum, an average, or some other holistic consideration of the risk scores associated with the risk categories 118, according to one embodiment.

If at least part of the risk score data 114 indicates that potential healthcare-based fraud is occurring or has occurred, the alert module uses risk reduction content 126 and performs one or more risk reduction actions 124 to attempt to address the potential healthcare-based fraud, according to one embodiment.

The risk reduction content 126 includes, but is not limited to, user experience elements such as banners, messages, audio clips, video clips, avatars, other types of multimedia, and/or other types of information that can be used to notify a healthcare provider, a patient, an insurance company, a system administrator, customer support, a user associated with an account that is under inspection, a government entity, and/or a state or federal revenue service, according to one embodiment.

In one embodiment, the risk reduction actions 124 include, but are not limited to, one or more of alerting one or more potentially affected entities of the likelihood of potential healthcare-based fraud, to enable the one or more potentially affected entities to notify appropriate authorities and/or increase scrutiny of activity associated with the potentially suspicious healthcare provider and/or the potentially suspicious claim submission.

In one embodiment, the risk reduction actions 124 include one or more of the following: notifying the healthcare provider of potential healthcare-based fraud associated with the potentially suspicious healthcare provider; notifying a manager of the healthcare provider of potential healthcare-based fraud associated with the potentially suspicious healthcare provider; notifying a controller of the healthcare provider of potential healthcare-based fraud associated with the potentially suspicious healthcare provider; notifying an auditor of potential healthcare-based fraud associated with the potentially suspicious healthcare provider; notifying a government entity of potential healthcare-based fraud associated with the potentially suspicious healthcare provider; notifying a healthcare provider network of potential healthcare-based fraud associated with the potentially suspicious healthcare provider; notifying a government entity of potential healthcare-based fraud associated with the potentially suspicious healthcare provider; notifying law enforcement agencies of potential healthcare-based fraud associated with the potentially suspicious healthcare provider; suspending insurance claim submissions associated with the potentially suspicious healthcare provider; and assigning customer support representatives to contact people who were or are patients of the potentially suspicious healthcare provider.

In one embodiment, the risk reduction actions 124 include alerting one or more potentially affected entities (e.g., the potentially affected entity system 160) of the likelihood of potential healthcare-based fraud, to enable the one or more potentially affected entities to increase scrutiny of activity associated with the potentially suspicious healthcare provider and/or notify appropriate authorities. In one embodiment, one of the risk reduction actions 124 includes transmitting one or more of the alerts 122 to the potentially affected entity system 160 of potential healthcare-based fraud.

In one embodiment, the one or more potentially affected entities include one or more entities potentially affected by the potential healthcare-based fraud. In one embodiment, the one or more potentially affected entities include one or more of the following potentially affected entities: an insurance provider; an insurance network; a government entity; a law enforcement agency; a healthcare provider; a healthcare provider network; and a healthcare provider management system.

In one embodiment, the fraud detection system 112 analyzes input data 119 in a batch mode. For example, the fraud detection system 112 periodically (e.g., at the end of each day, week, and/or month) fetches or receives fraudulent data and/or other input data 119 to perform analysis and/or model training to detect potential healthcare-based fraud associated with the claim submission system 111, according to one embodiment.

In one embodiment, the fraud detection system 112 provides real-time potential healthcare-based fraud identification and remediation services. Each time claim submission data 140 is received, the claim submission system 111 executes and/or calls the services of the fraud detection system 112 to generate risk score data 114 for the claim submission data and/or healthcare provider data for each session or request for access to the filing system 111, according to one embodiment. In one embodiment, the fraud detection system 112 continuously or periodically (e.g., every 1, 5, 10, 15 minutes, etc.) applies input to the one or more predictive models 116 to generate risk score data 114.

The service provider computing environment 110 and/or the claim submission system 111 and/or the fraud detection system 112 includes memory 127 and processors 128 to support operations of the claim submission system 111 and/or of the fraud detection system 112 in identifying and addressing potential healthcare-based fraud in the claim submission system 111, according to one embodiment. In one embodiment, the fraud detection system 112 includes instructions that are represented as data that are stored in the memory 127 and that are executed by one or more of the processors 128 to perform a method of identifying and addressing potential healthcare-based fraud in the claim submission system 111.

By receiving various information from the claim submission system 111, analyzing the received information, quantifying a likelihood of risk based on the information, and performing one or more risk reduction actions 124, the fraud detection system 112 works with the claim submission system 111 to improve the security of the claim submission system 111, according to one embodiment. In addition to improving the security of the claim submission system 111, the fraud detection system 112 protects financial interests of the government, of insurance companies, of healthcare providers, and of patients by maintaining and/or improving the security and functionality of the claim submission system 111, according to one embodiment. Furthermore, the fraud detection system 112 addresses the Internet-centric problem of healthcare providers filing fraudulent claim submissions, according to one embodiment.

### Process

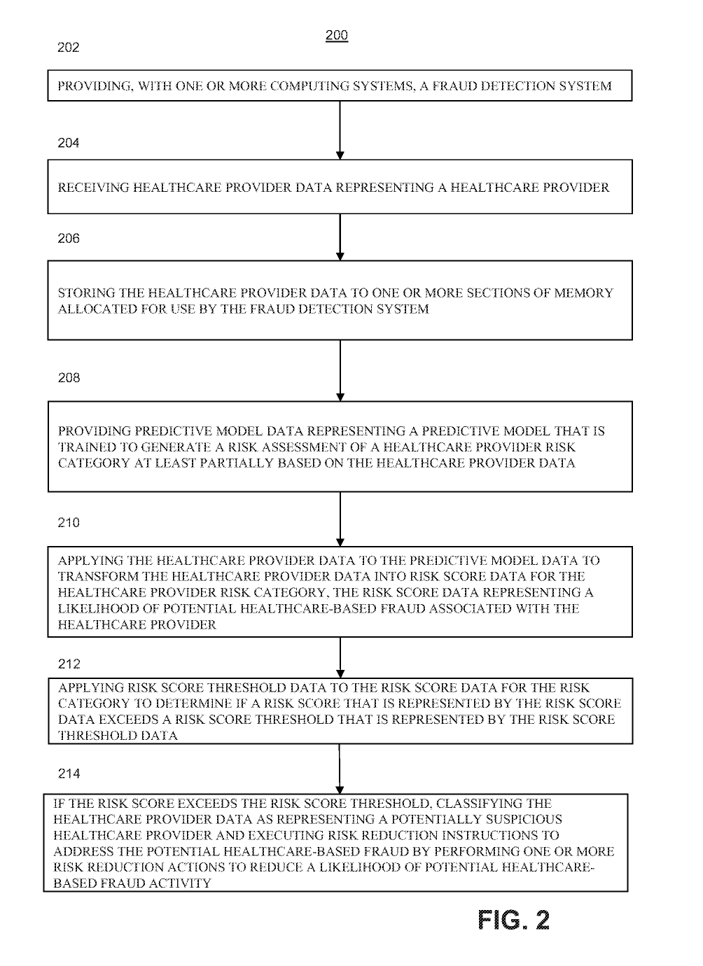

FIG. 2 illustrates an example flow diagram of a process 200 for identifying and addressing potential healthcare-based fraud.

In one embodiment, the potential healthcare based fraud includes one or more of Medicaid fraud; Medicare fraud; insurance fraud; inflated billings; billing for services not rendered; billing for a non-covered service as a covered service; misrepresentation of time of service; misrepresentation of locations of service: misrepresentation of provider of service; waiver of deductible and/or co-payment; overutilization of services; and false and/or unnecessary provision of prescription medication.

At operation 202, the process 200 includes providing, with one or more computing systems, a fraud detection system, according to one embodiment. Operation 202 proceeds to operation 204, according to one embodiment.

In one embodiment, at operation 204, the process 200 includes receiving healthcare provider data. In one embodiment, the healthcare provider data represents one or more characteristics and/or identifying information associated with a healthcare provider.

In one embodiment, the healthcare provider data includes one or more of healthcare provider identity data; healthcare provider type data; healthcare provider characteristics data; and healthcare provider statistical data.

In one embodiment, the healthcare provider data includes healthcare provider characteristics data, the healthcare provider characteristics data representing healthcare provider characteristics. In one embodiment, the healthcare provider characteristics include type of the healthcare provider; location of the healthcare provider; size of the healthcare provider; historical data associated with the healthcare provider; statistical data associated with the healthcare provider; population served by the healthcare provider; healthcare services provided by the healthcare provider; healthcare items provided by the healthcare provider; drugs prescribed the healthcare provider; number of prescriptions provided by the healthcare provider; number of insurance claims associated with the healthcare provider; number of employees of the healthcare provider; whether the healthcare provider is part of a larger healthcare provider network; change in income of the healthcare provider; and change in number of insurance claims associated with the healthcare provider.

According to one embodiment, operation 204 proceeds to operation 206. At operation 206, the process 200 includes storing the healthcare provider data to one or more sections of memory allocated for use by the fraud detection system, in one embodiment.

According to one embodiment, operation 206 proceeds to operation 208. In one embodiment, at operation 208, the process 200 includes providing predictive model data representing a predictive model that is trained to generate a risk assessment of a healthcare provider risk category at least partially based on the healthcare provider data. In one embodiment, the healthcare provider risk category includes one or more of a healthcare provider type risk category; a healthcare provider characteristics risk category; a healthcare provider statistical risk category; a healthcare provider insurance claim submission risk category; and a healthcare provider insurance claim submission characteristics risk category.

According to one embodiment, operation 208 proceeds to operation 210. At operation 210, the process 200 includes applying the healthcare provider data to the predictive model data to transform the healthcare provider data into risk score data for the healthcare provider risk category, the risk score data representing a likelihood of potential healthcare-based fraud associated with the healthcare provider, according to one embodiment. In one embodiment, operation 210 flows to operation 212.

In one embodiment, at operation 212, the process 200 includes applying risk score threshold data to the risk score data for the risk category to determine if a risk score that is represented by the risk score data exceeds a risk score threshold that is represented by the risk score threshold data.

In one embodiment, multiple predictive models are provided. In one embodiment, each risk category corresponds with an individual predictive model. The risk scores of the multiple predictive models are individually compared to their own risk score thresholds, to determine if any of the risk categories exceed a corresponding risk score threshold, according to one embodiment.

In one embodiment, operation 212 proceeds to operation 214. In one embodiment, if the risk score exceeds the risk score threshold, process 200 includes classifying the healthcare provider data as representing a potentially suspicious healthcare provider and executing risk reduction instructions to address the potential healthcare-based fraud by performing one or more risk reduction actions to reduce a likelihood of potential healthcare-based fraud activity at operation 214.

In one embodiment, if the risk scores are less than the risk score thresholds, the process 200 does not execute risk reduction instructions. In one embodiment, if the risk scores are equal to or less than the risk score thresholds, the process 200 does not execute risk reduction instructions.

In one embodiment, if the risk score exceeds the risk score threshold, the process 200 classifies the healthcare provider data that was transformed into the risk score data as potentially suspicious healthcare provider data. In one embodiment, if the risk score exceeds the risk score threshold, the process 200 classifies the healthcare provider associated with the healthcare provider data that was transformed into the risk score data as a potentially suspicious healthcare provider.

In one embodiment, the one or more risk reduction actions include one or more of the following risk reduction actions: notifying the healthcare provider of potential healthcare-based fraud associated with the potentially suspicious healthcare provider; notifying a manager of the healthcare provider of potential healthcare-based fraud associated with the potentially suspicious healthcare provider; notifying a controller of the healthcare provider of potential healthcare-based fraud associated with the potentially suspicious healthcare provider; notifying an auditor of potential healthcare-based fraud associated with the potentially suspicious healthcare provider; notifying a government entity of potential healthcare-based fraud associated with the potentially suspicious healthcare provider; notifying a healthcare provider network of potential healthcare-based fraud associated with the potentially suspicious healthcare provider; notifying a government entity of potential healthcare-based fraud associated with the potentially suspicious healthcare provider; notifying law enforcement agencies of potential healthcare-based fraud associated with the potentially suspicious healthcare provider; suspending insurance claim submissions associated with the potentially suspicious healthcare provider; and assigning customer support representatives to contact people who were or are patients of the potentially suspicious healthcare provider. In one embodiment, the term “notifying” includes alerting.

By suspending insurance claim submissions associated with the potentially suspicious healthcare provider, the process 200 prevents potentially fraudulent activity from occurring or further occurring, in one embodiment.

In one embodiment, the one or more risk reduction actions include alerting one or more potentially affected entities of the likelihood of potential healthcare-based fraud, to enable the one or more potentially affected entities to increase scrutiny of activity associated with the potentially suspicious healthcare provider and/or notify appropriate authorities.

In one embodiment, the one or more potentially affected entities include one or more entities potentially affected by the potential healthcare-based fraud. In one embodiment, the one or more potentially affected entities include one or more of the following: an insurance provider; an insurance network; a government entity; a law enforcement agency; a healthcare provider; a healthcare provider network; and a healthcare provider management system.

In one embodiment, the process 200 includes emailing, text messaging, or calling the one or more potentially affected entities to alert the one or more potentially affected entities of the potential healthcare-based fraud, according to one embodiment.

In one embodiment, the process 200 includes executing risk reduction instructions if any of the risk scores exceed their corresponding risk score thresholds, according to one embodiment.

In one embodiment, the process 200 includes executing risk reduction instructions if the average, sum, or other normalized result of the risk scores exceeds a general risk score threshold, according to one embodiment.

In one embodiment, the process 200 includes requesting the healthcare provider data associated with the potentially suspicious healthcare provider and applying a predictive model training operation to the healthcare provider data associated with the potentially suspicious healthcare provider, to generate the predictive model data and to train the predictive model.

In one embodiment, process 200 includes requesting one or more of system access data, the claim submission data, health service data, healthcare provider data, user data, and user system data associated with the potentially suspicious healthcare provider data and applying a predictive model training operation to one or more of the system access data, the claim submission data, health service data, healthcare provider data, user data, and user system data associated with the potentially suspicious healthcare provider data, to generate the predictive model data and to train the predictive model.

In one embodiment, the system access data includes one or more of data representing features or characteristics associated with an interaction between a healthcare provider system and the claim submission system; data representing a web browser of a healthcare provider system; data representing an operating system of a healthcare provider system; data representing a media access control address of the healthcare provider system; data representing user credentials used to access the user account; data representing a user account; data representing a user account identifier; data representing interaction behavior between a healthcare provider system and the claim submission system; data representing characteristics of an access session for the user account; data representing an IP address of a healthcare provider system; and data representing characteristics of an IP address of the healthcare provider system.

In one embodiment, the process 200 includes training one or more predictive models. In one embodiment, the process 200 includes training and re-training one or more predictive models. In one embodiment, the process 200 includes training and re-training one or more predictive models, on a periodic basis (e.g., at the end of each business day). In one embodiment, the process 200 includes training predictive models and/or re-training existing predictive models based on additional data samples (e.g., fraud data samples) acquired from the claim submission system and/or fraud detection system, according to one embodiment. For example, process 200 includes training new predictive models and/or retraining existing predictive models after 1, 10, 50, 100, etc. additional fraudulent activities are identified, to assist new predictive models in more accurately identifying subsequent cases of potential healthcare-based fraud, according to one embodiment.

In one embodiment, the predictive model training operation includes the following predictive model training operations: regression; logistic regression; decision tree; artificial neural network; support vector machine; linear regression; nearest neighbor analysis; distance based analysis; naive Bayes; linear discriminant analysis; and k-nearest neighbor analysis.

In one embodiment, the process 200 includes receiving patient data representing a patient of the healthcare provider; storing the patient data to one or more sections of memory allocated for use by the fraud detection system; providing predictive model data representing a predictive model that is trained to generate a risk assessment of a patient risk category at least partially based on the patient data; applying the patient data to the predictive model data to transform the patient data into patient risk score data for the patient risk category, the patient risk score data representing a likelihood of potential healthcare-based fraud associated with the patient of the healthcare provider; applying patient risk score threshold data to the patient risk score data for the patient risk category to determine if a patient risk score that is represented by the patient risk score data exceeds a patient risk score threshold that is represented by the patient risk score threshold data; and if the patient risk score exceeds the patient risk score threshold, classifying the patient of the healthcare provider as representing a patient of a potentially suspicious healthcare provider and executing risk reduction instructions to address the potential healthcare-based fraud by performing one or more risk reduction actions to reduce a likelihood of potential healthcare-based fraud activity.

In one embodiment, the process 200 is performed by a non-transitory computer readable medium and computer program code. In one embodiment, the computer program code is encoded on the non-transitory computer readable medium, comprising computer readable instructions. In one embodiment when one or more processors execute the computer readable instructions, the computer readable instructions perform a process for identifying and addressing potential healthcare-based fraud.

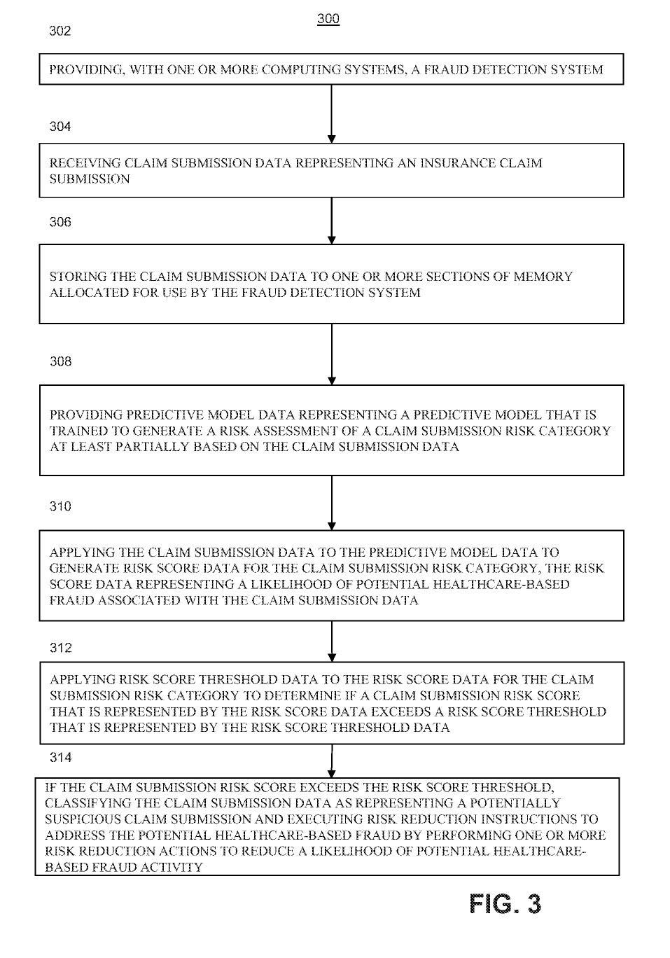

FIG. 3 illustrates an example flow diagram of a process 300 for identifying and addressing potential healthcare-based fraud, according to one embodiment.

In one embodiment, at operation 302, the process 300 includes providing, with one or more computing systems, a fraud detection system.

In one embodiment, operation 302 proceeds to operation 304. In one embodiment, at operation 304, the process 300 includes receiving claim submission data representing an insurance claim submission.

In one embodiment, operation 304 proceeds to operation 306. In one embodiment, at operation 306, the process 300 includes storing the claim submission data to one or more sections of memory allocated for use by the fraud detection system.

In one embodiment, operation 306 proceeds to operation 308. In one embodiment, at operation 308, the process 300 includes providing predictive model data representing a predictive model that is trained to generate a risk assessment of a claim submission risk category at least partially based on the claim submission data.

In one embodiment, operation 308 proceeds to operation 310. In one embodiment, at operation 310, the process 300 includes applying the claim submission data to the predictive model data to generate risk score data for the claim submission risk category, the risk score data representing a likelihood of potential healthcare-based fraud associated with the claim submission data.

In one embodiment, operation 310 proceeds to operation 312. In one embodiment, at operation 312, the process 300 includes applying risk score threshold data to the risk score data for the claim submission risk category to determine if a claim submission risk score that is represented by the risk score data exceeds a risk score threshold that is represented by the risk score threshold data.

In one embodiment, operation 312 proceeds to operation 314. In one embodiment, at operation 314, if the claim submission risk score exceeds the risk score threshold, the process 300 includes classifying the claim submission data as representing a potentially suspicious claim submission and executing risk reduction instructions to address the potential healthcare-based fraud by performing one or more risk reduction actions to reduce a likelihood of potential healthcare-based fraud activity, in one embodiment.

In one embodiment, the process 300 is performed by a non-transitory computer readable medium and computer program code. In one embodiment, the computer program code is encoded on the non-transitory computer readable medium, comprising computer readable instructions. In one embodiment when one or more processors execute the computer readable instructions, the computer readable instructions perform a process for identifying and addressing potential healthcare-based fraud.

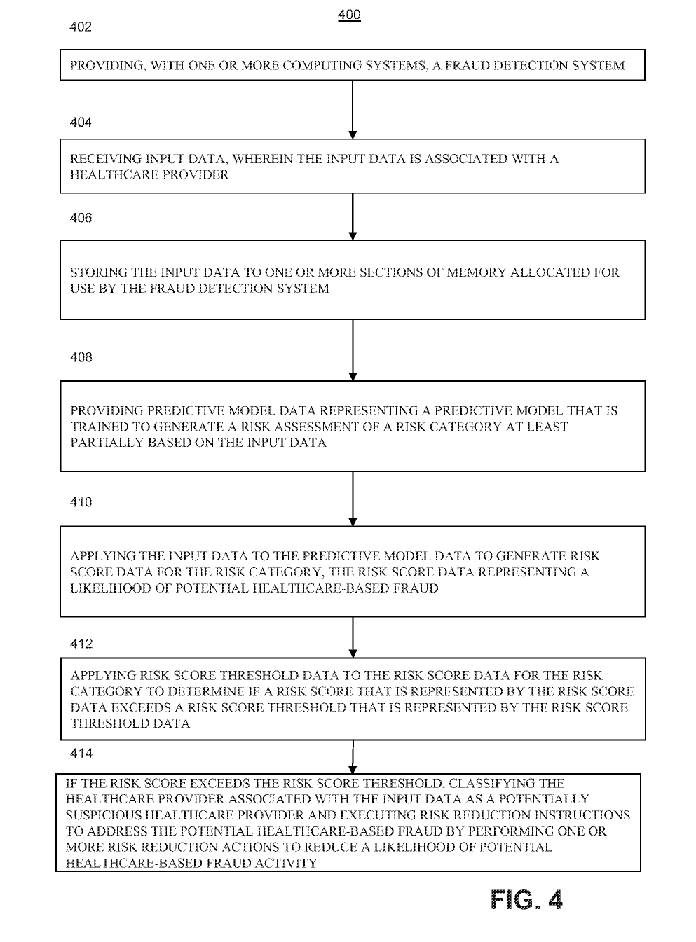

FIG. 4 illustrates an example flow diagram of a process 400 for identifying and addressing potential healthcare-based fraud.

At operation 402, the process 400 includes providing, with one or more computing systems, a fraud detection system, according to one embodiment.

Operation 402 proceeds to operation 404, according to one embodiment. At operation 404, the process 400 includes receiving input data, wherein the input data is associated with a healthcare provider, in one embodiment.

In one embodiment, input data includes, but is not limited to, healthcare provider data, claim submission data, patient data, heath service data, and/or insurance provider data.

Operation 404 proceeds to operation 406, according to one embodiment. In one embodiment, at operation 406, process 400 includes storing the input data to one or more sections of memory allocated for use by the fraud detection system.

Operation 406 proceeds to operation 408, in one embodiment. In one embodiment, at operation 408, process 400 includes providing predictive model data representing a predictive model that is trained to generate a risk assessment of a risk category at least partially based on the input data.

In one embodiment, the predictive model training operation includes one or more of regression; logistic regression; decision tree; artificial neural network; support vector machine; linear regression; nearest neighbor analysis; distance based analysis; naive Bayes; linear discriminant analysis; and k-nearest neighbor analysis.

Operation 408 proceeds to operation 410, in one embodiment. In one embodiment, at operation 410, process 400 includes applying the input data to the predictive model data to generate risk score data for the risk category, the risk score data representing a likelihood of potential healthcare-based fraud.

In one embodiment, all input data received is applied to the predictive model data representing one or more predictive models.

In one embodiment, operation 410 proceeds to operation 412. At operation 412, process 400 includes applying risk score threshold data to the risk score data for the risk category to determine if a risk score that is represented by the risk score data exceeds a risk score threshold that is represented by the risk score threshold data, in one embodiment.

In one embodiment, operation 412 proceeds to operation 414. At operation 414, if the risk score exceeds the risk score threshold, process 400 includes classifying the healthcare provider associated with the input data as a potentially suspicious healthcare provider and executing risk reduction instructions to address the potential healthcare-based fraud by performing one or more risk reduction actions to reduce a likelihood of potential healthcare-based fraud activity, in one embodiment.

In one embodiment, the process 400 is performed by a non-transitory computer readable medium and computer program code. In one embodiment, the computer program code is encoded on the non-transitory computer readable medium, comprising computer readable instructions. In one embodiment when one or more processors execute the computer readable instructions, the computer readable instructions perform a process for identifying and addressing potential healthcare-based fraud.

As noted above, the specific illustrative examples discussed above are but illustrative examples of implementations of embodiments of the method or process for identifying and addressing potential healthcare-based fraud. Those of skill in the art will readily recognize that other implementations and embodiments are possible. Therefore the discussion above should not be construed as a limitation on the claims provided below.

By identifying and addressing potential fraudulent activity (e.g., potential business entity-based fraud) in a claim submission system, implementation of embodiments of the present disclosure allows for significant improvement to the fields of data security, claim submission systems security, data collection, and data processing, according to one embodiment. As illustrative examples, by identifying and addressing potentially fraudulent activity, fraudsters can be deterred from criminal activity, the government, health insurers, and taxpayers may be spared financial losses, and criminally funded activities may be decreased due to less or lack of funding. As a result, embodiments of the present disclosure allow for reduced communication channel bandwidth utilization, and faster communications connections. Consequently, computing and communication systems implementing and/or providing the embodiments of the present disclosure are transformed into faster and more operationally efficient devices and systems.

In addition to improving overall computing performance, by identifying and addressing potentially fraudulent activity in a claim submission system, implementation of embodiments of the present disclosure represent a significant improvement to the efficient use of human and non-human resources. As one illustrative example, by identifying and addressing fraudulent activity in user accounts, fewer resources such as time and energy must be devoted to resolving issues associated with fraud.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various users under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating,” “accessing,” “adding,” “aggregating,” “alerting,” “applying,” “analyzing,” “associating,” “calculating,” “capturing,” “categorizing,” “classifying,” “comparing,” “creating,” “defining,” “detecting,” “determining,” “distributing,” “eliminating,” “encrypting,” “extracting,” “filtering,” “forwarding,” “generating,” “identifying,” “implementing,” “informing,” “monitoring,” “obtaining,” “posting,” “processing,” “providing,” “receiving,” “requesting,” “saving,” “sending,” “storing,” “substituting,” “transferring,” “transforming,” “transmitting,” “using,” etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the figures, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for identifying and addressing potential healthcare-based fraud, comprising:
providing, with one or more computing systems, a fraud detection system;
receiving healthcare provider data representing a healthcare provider;
storing the healthcare provider data to one or more sections of memory allocated for use by the fraud detection system;
providing predictive model data representing a predictive model that is trained to generate a risk assessment of a healthcare provider risk category at least partially based on the healthcare provider data;
applying the healthcare provider data to the predictive model data to transform the healthcare provider data into risk score data for the healthcare provider risk category, the risk score data representing a likelihood of potential healthcare-based fraud associated with the healthcare provider;
applying risk score threshold data to the risk score data for the risk category to determine if a risk score that is represented by the risk score data exceeds a risk score threshold that is represented by the risk score threshold data; and
if the risk score exceeds the risk score threshold, classifying the healthcare provider data as representing a potentially suspicious healthcare provider and executing risk reduction instructions to address the potential healthcare-based fraud by performing one or more risk reduction actions to reduce a likelihood of potential healthcare-based fraud activity.

2. The computing system implemented method of claim 1, wherein the potential healthcare based fraud includes one or more of:
Medicaid fraud;
Medicare fraud;
insurance fraud;
inflated billings;
billing for services not rendered;
billing for a non-covered service as a covered service;
misrepresentation of time of service;
misrepresentation of locations of service:
misrepresentation of provider of service;
waiver of deductible and/or co-payment;
overutilization of services; and
false and/or unnecessary provision of prescription medication.

3. The computing system implemented method of claim 1, wherein the healthcare provider data is selected from a group of healthcare provider data, consisting of:
healthcare provider identity data;
healthcare provider type data;
healthcare provider characteristics data; and
healthcare provider statistical data.

4. The computing system implemented method of claim 1, wherein the healthcare provider risk category is selected from a group of healthcare provider risk categories, consisting of:
a healthcare provider type risk category;
a healthcare provider characteristics risk category;
a healthcare provider statistical risk category;
a healthcare provider insurance claim submission risk category; and
a healthcare provider insurance claim submission characteristics risk category.

5. The computing system implemented method of claim 1, further comprising:
receiving patient data representing a patient of the healthcare provider;
storing the patient data to one or more sections of memory allocated for use by the fraud detection system;
providing predictive model data representing a predictive model that is trained to generate a risk assessment of a patient risk category at least partially based on the patient data;
applying the patient data to the predictive model data to transform the patient data into patient risk score data for the patient risk category, the patient risk score data representing a likelihood of potential healthcare-based fraud associated with the patient of the healthcare provider;
applying patient risk score threshold data to the risk score data for the patient risk category to determine if a patient risk score that is represented by the patient risk score data exceeds a patient risk score threshold that is represented by the patient risk score threshold data; and
if the patient risk score exceeds the patient risk score threshold, classifying the patient of the healthcare provider as representing a patient of a potentially suspicious healthcare provider and executing risk reduction instructions to address the potential healthcare-based fraud by performing one or more risk reduction actions to reduce a likelihood of potential healthcare-based fraud activity.

6. The computing system implemented method of claim 1, wherein the healthcare provider data includes healthcare provider characteristics data, the healthcare provider characteristics data representing healthcare provider characteristics, wherein at least one characteristic of the healthcare provider characteristics is selected from a group of healthcare provider characteristics, consisting of:
type of the healthcare provider;
location of the healthcare provider;
size of the healthcare provider;
historical data associated with the healthcare provider;
statistical data associated with the healthcare provider;
population served by the healthcare provider;
healthcare services provided by the healthcare provider;
healthcare items provided by the healthcare provider;
drugs prescribed the healthcare provider;
number of prescriptions provided by the healthcare provider;
number of insurance claims associated with the healthcare provider;
number of employees of the healthcare provider;
whether the healthcare provider is part of a larger healthcare provider network;
change in income of the healthcare provider; and
change in number of insurance claims associated with the healthcare provider.

7. The computing system implemented method of claim 1, further comprising:
requesting the healthcare provider data associated with the potentially suspicious healthcare provider; and
applying a predictive model training operation to the healthcare provider data associated with the potentially suspicious healthcare provider, to generate the predictive model data and to train the predictive model.

8. The computing system implemented method of claim 7, wherein the predictive model training operation is selected from a group of predictive model training operations, consisting of:
regression;
logistic regression;
decision tree;
artificial neural network;
support vector machine;
linear regression;
nearest neighbor analysis;
distance based analysis;
naive Bayes;
linear discriminant analysis; and
k-nearest neighbor analysis.

9. The computing system implemented method of claim 1, wherein the one or more risk reduction actions includes alerting one or more potentially affected entities of the likelihood of potential healthcare-based fraud, to enable the one or more potentially affected entities to increase scrutiny of activity associated with the potentially suspicious healthcare provider and/or notify appropriate authorities.

10. The computing system implemented method of claim 9, wherein the one or more potentially affected entities include one or more potentially affected entities selected from a group of potentially selected entities, consisting of:
an insurance provider;
an insurance network;
a government entity;
a law enforcement agency;
a healthcare provider;
a healthcare provider network; and
a healthcare provider management system.

11. The computing system implemented method of claim 1, wherein the one or more risk reduction actions is selected from a group of risk reduction actions, comprising:
notifying the healthcare provider of potential healthcare-based fraud associated with the potentially suspicious healthcare provider;
notifying a manager of the healthcare provider of potential healthcare-based fraud associated with the potentially suspicious healthcare provider;
notifying a controller of the healthcare provider of potential healthcare-based fraud associated with the potentially suspicious healthcare provider;
notifying an auditor of potential healthcare-based fraud associated with the potentially suspicious healthcare provider;
notifying a government entity of potential healthcare-based fraud associated with the potentially suspicious healthcare provider;
notifying a healthcare provider network of potential healthcare-based fraud associated with the potentially suspicious healthcare provider;
notifying a government entity of potential healthcare-based fraud associated with the potentially suspicious healthcare provider;
notifying law enforcement agencies of potential healthcare-based fraud associated with the potentially suspicious healthcare provider;
suspending insurance claim submissions associated with the potentially suspicious healthcare provider; and
assigning customer support representatives to contact people who were or are patients of the potentially suspicious healthcare provider.

12. A computing system implemented method for identifying and addressing potential healthcare-based fraud, comprising:
providing, with one or more computing systems, a fraud detection system;
receiving claim submission data representing an insurance claim submission;
storing the claim submission data to one or more sections of memory allocated for use by the fraud detection system;
providing predictive model data representing a predictive model that is trained to generate a risk assessment of a claim submission risk category at least partially based on the claim submission data;
applying the claim submission data to the predictive model data to generate risk score data for the claim submission risk category, the risk score data representing a likelihood of potential healthcare-based fraud associated with the claim submission data;
applying risk score threshold data to the risk score data for the claim submission risk category to determine if a claim submission risk score that is represented by the risk score data exceeds a risk score threshold that is represented by the risk score threshold data; and
if the claim submission risk score exceeds the risk score threshold, classifying the claim submission data as representing a potentially suspicious claim submission and executing risk reduction instructions to address the potential healthcare-based fraud by performing one or more risk reduction actions to reduce a likelihood of potential healthcare-based fraud activity.

13. The computing system implemented method of claim 12, wherein the potential healthcare based fraud includes one or more of:
Medicaid fraud;
Medicare fraud;
insurance fraud;
inflated billings;
billing for services not rendered;
billing for a non-covered service as a covered service;
misrepresentation of time of service;
misrepresentation of locations of service:
misrepresentation of provider of service;
waiver of deductible and/or co-payment;
overutilization of services; and
false and/or unnecessary provision of prescription medication.

14. The computing system implemented method of claim 12, wherein the claim submission data is selected from a group of claim submission data, consisting of:
claim submission type data;
claim submission characteristics data; and
claim submission statistical data.

15. The computing system implemented method of claim 12, wherein the claim submission risk category is selected from a group of claim submission risk categories, consisting of:
a claim submission type risk category;
a claim submission characteristics risk category; and
a claim submission statistical risk category.

16. The computing system implemented method of claim 12, further comprising:
receiving healthcare provider data representing a healthcare provider;
storing the healthcare provider data to one or more sections of memory allocated for use by the fraud detection system;
providing healthcare provider risk predictive model data representing a healthcare provider risk predictive model that is trained to generate a risk assessment of a healthcare provider risk category at least partially based on the healthcare provider data;
applying the healthcare provider data to the healthcare provider risk predictive model data to generate healthcare provider risk score data for the healthcare provider risk category, the healthcare provider risk score data representing a likelihood of potential healthcare-based fraud associated with the healthcare provider;
applying healthcare provider risk score threshold data to the healthcare provider risk score data for the healthcare provider risk category to determine if a healthcare provider risk score that is represented by the healthcare provider risk score data exceeds a healthcare provider risk score threshold that is represented by the healthcare provider risk score threshold data; and
if the healthcare provider risk score exceeds the healthcare provider risk score threshold, classifying the healthcare provider data as representing a potentially suspicious healthcare provider and executing risk reduction instructions to address the potential healthcare-based fraud by performing one or more risk reduction actions to reduce the likelihood of potential healthcare-based fraud activity.

17. The computing system implemented method of claim 12, wherein the claim submission data includes claim submission characteristics data, the claim submission characteristics data representing claim submission characteristics, wherein at least one characteristic of the claim submission characteristics is selected from a group of claim submission characteristics, consisting of:
type of the claim submission;
one or more procedures associated with the claim submission;
one or more services associated with the claim submission;
one or more supplies associated with the claim submission;
equipment associated with the claim submission;
one or more diseases associated with the claim submission;
one or more conditions associated with the claim submission healthcare provider associated with the claim submission;
patient associated with claim submission;
one or more codes associated with the claim submission;
historical data associated with the claim submission; and
statistical data associated with the claim submission.

18. The computing system implemented method of claim 12, further comprising:
requesting the claim submission data associated with the potentially claim submission; and
applying a predictive model training operation to the claim submission data associated with the potentially suspicious claim submission, to generate the predictive model data and to train the predictive model.

19. The computing system implemented method of claim 18, wherein the predictive model training operation is selected from a group of predictive model training operations, consisting of:
regression;
logistic regression;
decision tree;
artificial neural network;
support vector machine;
linear regression;
nearest neighbor analysis;
distance based analysis;
naive Bayes;
linear discriminant analysis; and
k-nearest neighbor analysis.

20. The computing system implemented method of claim 12, wherein the one or more risk reduction actions includes alerting one or more potentially affected entities of the likelihood of potential healthcare-based fraud, to enable the one or more potentially affected entities to increase scrutiny of activity associated with the potentially suspicious claim submission and/or notify appropriate authorities.

21. The computing system implemented method of claim 20, wherein the one or more potentially affected entities include one or more potentially affected entities selected from a group of potentially selected entities, consisting of:
an insurance provider;
an insurance network;
a government entity;
a law enforcement agency;
a healthcare provider;
a healthcare provider network; and
a healthcare provider management system.

22. The computing system implemented method of claim 12, wherein the one or more risk reduction actions is selected from a group of risk reduction actions, comprising:
notifying a healthcare provider of potential healthcare-based fraud associated with the potentially suspicious claim submission;
notifying a manager of the healthcare provider of potential healthcare-based fraud associated with the potentially suspicious claim submission;
notifying a controller of the healthcare provider of potential healthcare-based fraud associated with the potentially suspicious claim submission;
notifying an auditor of potential healthcare-based fraud associated with the potentially suspicious claim submission;
notifying a government entity of potential healthcare-based fraud associated with the potentially suspicious claim submission;
notifying a healthcare provider network of potential healthcare-based fraud associated with the potentially suspicious claim submission;
notifying a government entity of potential healthcare-based fraud associated with the potentially suspicious claim submission;
notifying law enforcement agencies of potential healthcare-based fraud associated with the potentially suspicious claim submission;
suspending insurance claim submissions from a healthcare provider associated with the potentially suspicious claim submission; and
assigning customer support representatives to contact people who were or are patients of the healthcare provider associated with the potentially suspicious claim submission.

23. A computing program product for identifying and addressing potential healthcare-based fraud, comprising:
a non-transitory computer readable medium; and
computer program code, encoded on the computer readable medium, comprising computer readable instructions, which, when executed by one or more processors, performs a process for identifying and addressing potential healthcare-based fraud, the process for identifying and addressing potential healthcare-based fraud including:
providing, with one or more computing systems, a fraud detection system;
receiving healthcare provider data representing a healthcare provider;
storing the healthcare provider data to one or more sections of memory allocated for use by the fraud detection system;
providing predictive model data representing a predictive model that is trained to generate a risk assessment of a healthcare provider risk category at least partially based on the healthcare provider data;
applying the healthcare provider data to the predictive model data to transform the healthcare provider data into risk score data for the healthcare provider risk category, the risk score data representing a likelihood of potential healthcare-based fraud associated with the healthcare provider;
applying risk score threshold data to the risk score data for the risk category to determine if a risk score that is represented by the risk score data exceeds a risk score threshold that is represented by the risk score threshold data; and
if the risk score exceeds the risk score threshold, classifying the healthcare provider data as representing a potentially suspicious healthcare provider and executing risk reduction instructions to address the potential healthcare-based fraud by performing one or more risk reduction actions to reduce a likelihood of potential healthcare-based fraud activity.

24. The computing program product of claim 23, wherein the potential healthcare based fraud includes one or more of:
Medicaid fraud;
Medicare fraud;
insurance fraud;
inflated billings;
billing for services not rendered;
billing for a non-covered service as a covered service;
misrepresentation of time of service;
misrepresentation of locations of service:
misrepresentation of provider of service;
waiver of deductible and/or co-payment;
overutilization of services; and
false and/or unnecessary provision of prescription medication.

25. The computing program product of claim 23, wherein the healthcare provider data is selected from a group of healthcare provider data, consisting of:
healthcare provider identity data;
healthcare provider type data;
healthcare provider characteristics data; and
healthcare provider statistical data.

26. The computing program product of claim 23, wherein the healthcare provider risk category is selected from a group of healthcare provider risk categories, consisting of:
a healthcare provider type risk category;
a healthcare provider characteristics risk category;
a healthcare provider statistical risk category;
a healthcare provider insurance claim submission risk category; and
a healthcare provider insurance claim submission characteristics risk category.

27. The computing program product of claim 23, further comprising:
receiving patient data representing a patient of the healthcare provider;
storing the patient data to one or more sections of memory allocated for use by the fraud detection system;
providing predictive model data representing a predictive model that is trained to generate a risk assessment of a patient risk category at least partially based on the patient data;
applying the patient data to the predictive model data to transform the patient data into patient risk score data for the patient risk category, the patient risk score data representing a likelihood of potential healthcare-based fraud associated with the patient of the healthcare provider;
applying patient risk score threshold data to the risk score data for the patient risk category to determine if a patient risk score that is represented by the patient risk score data exceeds a patient risk score threshold that is represented by the patient risk score threshold data; and
if the patient risk score exceeds the patient risk score threshold, classifying the patient of the healthcare provider as representing a patient of a potentially suspicious healthcare provider and executing risk reduction instructions to address the potential healthcare-based fraud by performing one or more risk reduction actions to reduce a likelihood of potential healthcare-based fraud activity.

28. The computing program product of claim 23, wherein the healthcare provider data includes healthcare provider characteristics data, the healthcare provider characteristics data representing healthcare provider characteristics, wherein at least one characteristic of the healthcare provider characteristics is selected from a group of healthcare provider characteristics, consisting of:
type of the healthcare provider;
location of the healthcare provider;
size of the healthcare provider;
historical data associated with the healthcare provider;
statistical data associated with the healthcare provider;
population served by the healthcare provider;
healthcare services provided by the healthcare provider;
healthcare items provided by the healthcare provider;
drugs prescribed the healthcare provider;
number of prescriptions provided by the healthcare provider;
number of insurance claims associated with the healthcare provider;
number of employees of the healthcare provider;
whether the healthcare provider is part of a larger healthcare provider network;
change in income of the healthcare provider; and
change in number of insurance claims associated with the healthcare provider.

29. The computing program product of claim 23, further comprising:
requesting the healthcare provider data associated with the potentially suspicious healthcare provider; and
applying a predictive model training operation to the healthcare provider data associated with the potentially suspicious healthcare provider, to generate the predictive model data and to train the predictive model.

30. The computing program product of claim 29, wherein the predictive model training operation is selected from a group of predictive model training operations, consisting of:
regression;
logistic regression;
decision tree;
artificial neural network;
support vector machine;
linear regression;
nearest neighbor analysis;
distance based analysis;
naive Bayes;
linear discriminant analysis; and
k-nearest neighbor analysis.

31. The computing program product of claim 23, wherein the one or more risk reduction actions includes alerting one or more potentially affected entities of the likelihood of potential healthcare-based fraud, to enable the one or more potentially affected entities to increase scrutiny of activity associated with the potentially suspicious healthcare provider and/or notify appropriate authorities.

32. The computing program product of claim 31, wherein the one or more potentially affected entities include one or more potentially affected entities selected from a group of potentially selected entities, consisting of:
an insurance provider;
an insurance network;
a government entity;
a law enforcement agency;
a healthcare provider;
a healthcare provider network; and
a healthcare provider management system.

33. The computing program product of claim 23, wherein the one or more risk reduction actions is selected from a group of risk reduction actions, comprising:
notifying the healthcare provider of potential healthcare-based fraud associated with the potentially suspicious healthcare provider;
notifying a manager of the healthcare provider of potential healthcare-based fraud associated with the potentially suspicious healthcare provider;
notifying a controller of the healthcare provider of potential healthcare-based fraud associated with the potentially suspicious healthcare provider;
notifying an auditor of potential healthcare-based fraud associated with the potentially suspicious healthcare provider;
notifying a government entity of potential healthcare-based fraud associated with the potentially suspicious healthcare provider;
notifying a healthcare provider network of potential healthcare-based fraud associated with the potentially suspicious healthcare provider;
notifying a government entity of potential healthcare-based fraud associated with the potentially suspicious healthcare provider;
notifying law enforcement agencies of potential healthcare-based fraud associated with the potentially suspicious healthcare provider;
suspending insurance claim submissions associated with the potentially suspicious healthcare provider; and
assigning customer support representatives to contact people who were or are patients of the potentially suspicious healthcare provider.
